(19) United States
(12) Patent Application Publication
(10) Pub. No.: US 2005/0134726 A1
(43) Pub. Date: Jun. 23, 2005

(54) Modular print scanner and digital imaging system

(76) Inventors: Kenneth A. Parulski, Rochester, NY (US); Joseph A. Manico, Rochester, NY (US); John R. Fredlund, Rochester, NY (US)

Correspondence Address: Pamela R. Crocker;Patent Legal Staff, Eastman Kodak Company, 343 State Street, Rochester, NY, 14650-2201, US

(21) Appl. No.: 10/740,221

(22) Filed: Dec. 18, 2003

(51) Int. Cl. H04N 5/225; H04N 1/21; G03B 17/48; G03B 29/00; H04N 11/00; H04N 7/00; G03B 19/00; H04N 1/23

(52) U.S. Cl. 348/373; 348/375; 348/552; 358/296; 358/906; 396/429

(57) ABSTRACT

A scanner module adapted to receive a capture device for capturing a still image. The module includes a body having a planar support surface, a recessed area for receiving a hardcopy print to be scanned, and a support member movable relative to the planar support surface wherein the support member is adapted to receive the capture device.

### FIELD OF THE INVENTION

The present invention relates generally to digital imaging, and more particularly, to a modular digital imaging system including a print scanner.

### BACKGROUND OF THE INVENTION

Digital imaging systems are well known and can include, for example, digital scanners, digital cameras, digital displays, camcorders, digital video recorders, computers, and kiosks. For example, digital flatbed scanners can be connected to a host computer to enable documents and photographic prints to be converted into digital image files which can then be stored, viewed, or transmitted by the computer.

Digital cameras can be connected to a host computer by means of a “dock” or other transfer devices in order to transfer digital data to a computer. This digital data can include digital still images (e.g., JPEG files) as well as motion video files (e.g., Quick Time files). One example of such a digital camera is the Kodak EasyShare DX3600 digital camera, which can be connected with an optional docking unit. The digital camera captures digital still images and motion video segments, and stores the images using Flash EPROM memory. The still images and motion video files can be downloaded from the digital camera to the computer using the docking unit.

Such a digital camera can include a close focusing (e.g., macro) mode that allows a small object, such as a photographic print, to be captured. However, the resulting digital image of the print might be of limited quality, for example, if the illumination of the print is non-uniform, and if the proper camera to print alignment is not maintained.

Accordingly, there exists a need for a digital imaging system which is modular, transportable, and which enables photographic prints to be captured readily and without the use of a computer.

### SUMMARY OF THE INVENTION

An object of the present invention is to provide a digital imaging system which includes a capture device and a scanner module which illuminates a hardcopy/photographic print and which holds the capture device in an orientation to allow scanning of the print.

Another object of the present invention is to provide such a scanner module which is compact or can be compactly stored.

Yet another object of the present invention is to provide a variety of modular components, including a capture device and a scanner module, that can be combined by a user to form a custom product that has the appearance and function of an integrated digital imaging system.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a scanner module adapted to receive a capture device for capturing a still image, comprising a body having a planar support surface, a recessed area for receiving a hardcopy print to be scanned, and a support member angled relative to the planar support surface; and the support member being adapted to receive the capture device.

According to another aspect of the invention, there is provided a scanner module adapted to receive a capture device for capturing a still image, comprising a body having a planar support surface, a recessed area for receiving a hardcopy print to be scanned, and a movable support member pivotable relative to the planar support surface; and the movable support member being adapted to receive the capture device, the support member being movable between a first and a second position, the first position provides a scanning position and the second position provides a storage position wherein the capture device is substantially disposed within the recessed area.

According to yet another aspect of the present invention, there is provided a scanner module, comprising a body defining a recessed area for receiving a print to be scanned, a support member adapted to accept a capture device, the support member being pivotably connected to the body about an axis between a first position and a second position wherein the support member is disposed substantially within the recessed area; and power means adapted to provide power to the capture module.

According to a still further aspect of the present invention, there is provided a system for scanning a print, comprising a capture device including a capture assembly having a lens and a display for displaying captured images, the capture assembly pivoting relative to the display; and a scanner module including a body having a planar support surface including an area for receiving a hardcopy print to be scanned, and a support member angled relative to the planar support surface, the support member being adapted to receive the capture device.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a perspective view of a capture device.

FIG. 2 shows a perspective view of a display module.

FIG. 3 shows a perspective view of a digital imaging system comprising the capture device shown in FIG. 1 and the display module shown in FIG. 2.

FIG. 4 shows a perspective view of a CD module.

FIG. 5 shows a perspective view of a printer module.

FIG. 6 shows a perspective view of a modular digital imaging system including the display module shown in FIG. 2.

FIG. 7 shows a perspective view of a scanner module in accordance with the present invention.

FIG. 8 shows a perspective view of a digital imaging system in accordance with the present invention comprising the capture device shown in FIG. 1 and the scanner module shown in FIG. 7.

FIG. 9 shows a perspective view of a modular digital imaging system in accordance with the present invention including the scanner module shown in FIG. 7.

### DETAILED DESCRIPTION OF THE INVENTION

The following is a detailed description of the preferred embodiments of the invention, reference being made to the drawings in which the same reference numerals identify the same elements of structure in each of the several figures.

Reference is made to commonly assigned U.S. Patent Application No. 2003/0210333 (Manico et al) titled “MODULAR DIGITAL IMAGING SYSTEM” and U.S. Patent Application No. 2003/0218681 titled “DISPLAY MODULE FOR SUPPORTING A DIGITAL IMAGE DISPLAY DEVICE” (Manico et al), both of which are incorporated herein by reference.

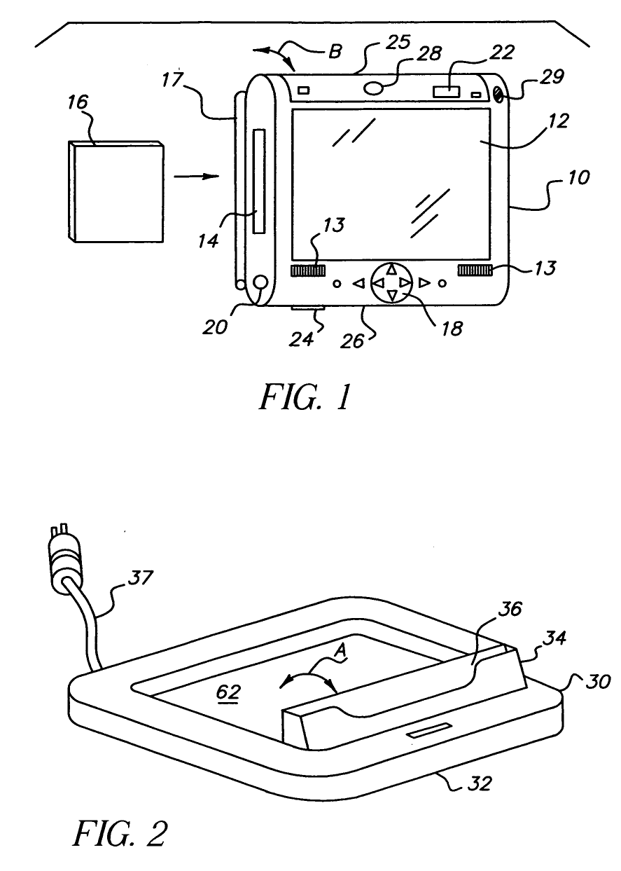

FIG. 1 shows a capture device 10 in accordance with the present invention. Capture device 10 comprises an image display 12 for displaying a digital image, and a receiving port 14 for receiving a digital data storage device 16. In FIG. 1, receiving port 14 is configured as a slot/aperture adapted to receive a digital data storage device 16 such as a memory card. Other digital data storage devices are known to those skilled in the art. Image display 12 can be a color LCD, an organic light emitting display (OLED), or the like, as known to those skilled in the art. Accordingly, capture device 10 can display digital images. Capture device 10 preferably comprises at least one speaker 13.

Capture device 10 can comprise a cover member 17, which is shown in FIG. 1 as being folded back away from display 12 to abut or be proximate to a side of capture device 10 opposite display 12.

Capture device 10 further comprises at least one selection member 18 for selecting and/or manipulating (e.g., zoom, crop, delete) a digital image displayed on display 12. FIG. 1 illustrates a plurality of selection members, shown as buttons, arrows, and a four-way selection button, which can be employed to provide instructions to capture device 10 to display a digital image on display 12. Display 12 can be configured as a touch screen. Accordingly, a physical contact with display 12 would be used to select or provide instructions to display 12. The physical contact with display 12 can be accomplished, for example, by a finger contacting display 12 or by employing a stylus. A stylus can be provided with capture device 10 and stored in an aperture 20 disposed in capture device 10 for ready access by a user.

The capture device 10 serves as a digital camera, to capture digital still images, in addition to displaying digital images. The capture device 10 can be configured to also capture and display motion video images and sound. Capture device 10 comprises a flash member or other illumination device 22 as well as a lens 28, which are mounted on a rotating capture assembly 25 which rotates about an axis as shown by arrow B. Lens 28 can be employed when capturing an image. Rotating capture assembly 25 can be rotated to a position which directs lens 28 toward a subject while the user previews the image to be captured on the display 12.

Capture device 10 also comprises an activation member 29 (i.e., shutter button) for activating capture device 10 to capture an image. Capture device 10 can further include elements employed for image capture and image processing, such as an image sensor (e.g., CCD, CMOS), analog-to-digital converter, and digital image processor. Examples of such elements are disclosed in U.S. Pat. No. 6,292,218, issued Sep. 18, 2001, titled “Electronic camera for initiating capture of still images while previewing motion images”, by Parulski et al., incorporated herein by reference.

Capture device 10 can further comprise a communication port 24 for communicating with another device. Communication port 24 is shown in FIG. 1 as a USB connection disposed on a lower edge 26 of capture device 10. Other configurations for a communication port are known to those skilled in the art.

Referring now to FIG. 2, there is shown a perspective view of a first module referred to, for ease of discussion, as a display dock or display module 30. Display module 30 comprises a body 32 and a support member 34 pivotably connected to body 32 so as to pivot in a direction as shown by arrow A in FIG. 2. The pivoting operation may be achieved by manual manipulation by the user. Support member 34 comprises a recess 36 adapted to receive and support capture device 10. When capture device 10 is positioned in recess 36 and pivoted to a full horizontal position, capture device 10 is disposed within display module 30 in a display recess 62. As such, display module 30 provides some protection/support/shielding of capture device 10. Display module 30 can further comprise an electrical connector 37.

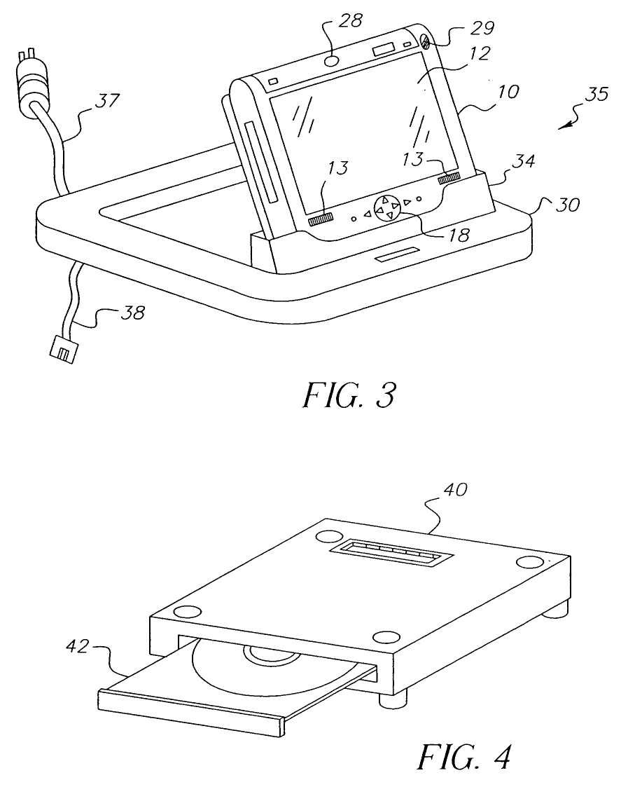

FIG. 3 shows capture device 10 disposed within support member 34 of display module 30 to define a digital imaging system 35 in accordance with the present invention. As shown, lower edge 26 of capture device 10 is inserted into recess 36 such that the portion of capture device 10 adjacent lower edge 26 is supported within support member 34, preferably permitting an unobstructed view of display 12 of capture device 10 by a user/viewer. That is, an image displayed in display 12 can be viewed while capture device 10 is docked within display module 30; display 12 is not obstructed from a user's view. Similarly, speakers 13 are preferably unobstructed by support member 34 so as not to interfere with sound reproduction. Alternatively, display module 30 and support member 34 may be designed to incorporate sound directing ports and/or baffles to enhance the quality of the sound. Display module 30 acts as a holder or support for capture device 10. Support member 34 can be pivoted to provide a preferred viewing angle of display 12 by a user. In a preferred embodiment, selection members 18 are accessible when capture device 10 is supported by display module 30.

If display module 30 is provided with electrical connector 37, display module 30 can be configured as a power source for capture device 10 or as a charger for a power supply (e.g., battery) disposed within capture device 10. Additionally, display recess 62 in display module 30 may incorporate an additional connector for charging additional batteries.

Disposed within recess 36 is a communication connector (not shown) which can be matingly connected with communication port 24 of capture device 10 when capture device 10 is docked within display module 30. When docked, a communication network is established by connecting communication port 24 and the communication connector, thereby permitting the transfer of digital data. For example, display module 30 can comprise a modem and a telephone connector 38 (shown in FIG. 3), whereby digital data can be transmitted by means of a telephone connection. It is recognized that other communication networks known to those skilled in the art can be employed in addition to a wired communication network, for example, a cellular or wireless communication network. An example of a wireless communication network is a radio frequency transponder and receiver disposed with capture device 10 and display module 30.

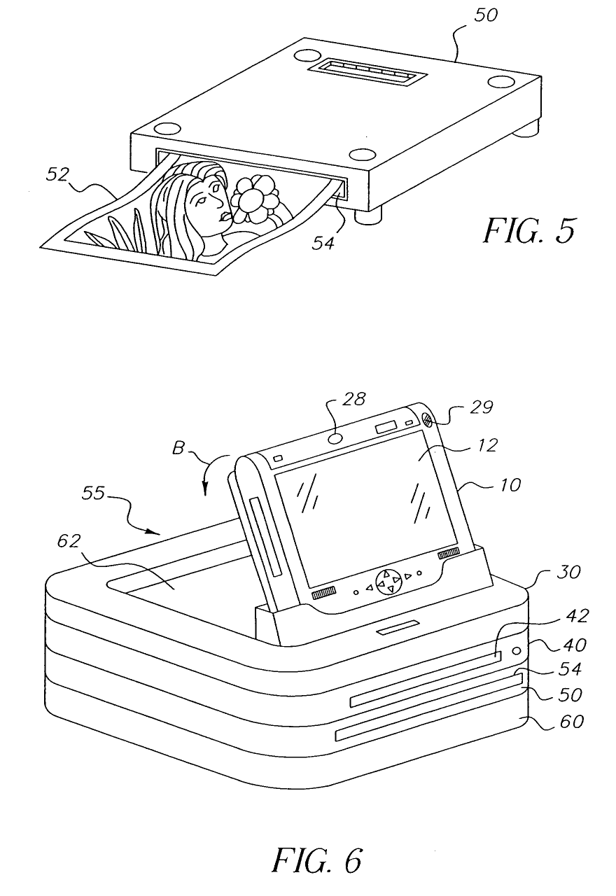

Display module 30 is one example of a module that can be employed with capture device 10. Additional modules can be employed with capture device 10. A compact disc (CD) module 40 is shown in FIG. 4 as having an opening 42 by which to receive a CD for reading or writing to the CD. A printer module 50 is shown in FIG. 5 for providing a hardcopy print 52 through a delivery aperture 54.

Preferably, each module is configured to have a complementary shape such that when the modules abut, a modular system is provided. FIG. 6 generally illustrates a perspective view of such a modular digital imaging system 55 in accordance with the present invention comprising display module 30 and at least one other module. The particular digital imaging system 55 shown in FIG. 6 comprises display module 30, CD module 40, printer module 50, and another module 60. Examples of other modules 60 include a DVD module for reading or writing DVDs, a telecommunication module (cellular, wired, or wireless), a videophone module, a stereo module for providing amplified stereo sound and high quality speakers, a battery pack module (for example, comprising a heavy duty battery for providing extended operation of the digital imaging system without recharging or connection to an electrical outlet), a hard drive module, a modem module, a television turner module, a digital tape drive module, computer connection module, illumination module, digital projector, film writer, film scanner, and an additional memory module.

Module 60 can be, for example, a “dummy” module. That is, it can be a decorative, functional, or non-functional module. For example, it can be a storage module having a recessed area for storage for batteries, cabling, manuals, print media, memory cards, CDs, or the like. Alternatively, the dummy module may serve as a base to raise the digital imaging system to a particular height for preferred viewing by a user. Alternatively, a transformer for providing electrical power can be disposed within a dummy module.

As configured, the modules are docking docks. That is, when a module is docked with another module, a system of docks is formed. The complementary shapes of the modules provides for an interlocking arrangement of the modules, which in addition to being aesthetically pleasing, provides a physically robust digital imaging system.

The modules can be arranged in a vertical orientation, as shown in FIG. 6. Alternatively, the modules can be arranged in a horizontal orientation with capture device 10 being disposed on top of or adjacent to one of the modules.

With a modular system, the order of the modules is not relevant; any order can be employed, though in a preferred embodiment capture device 10 is disposed on top for optimal viewing.

Access to the modules (e.g., 30, 40, 50, 60) is preferably in the same direction (i.e., on the same side) of digital imaging system 55, as shown in FIG. 6. Preferably, opening 42 of CD module 40 and delivery aperture 54 of printer module 50 are directed toward the viewer, so as to provide ready access to the modules. Likewise, display 12 is preferably arranged so as to be viewed forward regardless of lens orientation, in the same direction as the access to the modules, for viewing an image through display 12 when capture device 10 is docked in display module 30. It may be preferred to orient lens 28 toward the user whenever the capture device 10 is inserted in display module 30 to facilitate two way visual communication. Similarly, access for any media (i.e., paper for printer module 50) would preferably be obtained from the same forward direction.

Once docked, the electrical connection of the module is made with the other modules, particularly display module 30 which provides an interface to capture device 10.

In a preferred embodiment, the user interface for digital imaging system 35, 55 is not contained with module 40, 50, 60. Rather, user control would be provided by capture device 10 or display module 30. Accordingly, each time a module 40, 50, 60 is docked, software for the module would be uploaded or accessed by capture device 10 or display module 30. This software may be uploaded from firmware within the modules or via the communications link 38 or via the removable digital memory device 16. As such, a cumulative user interface is provided. The user interface can be designed with a consistent look and feel for all modules added to the system.

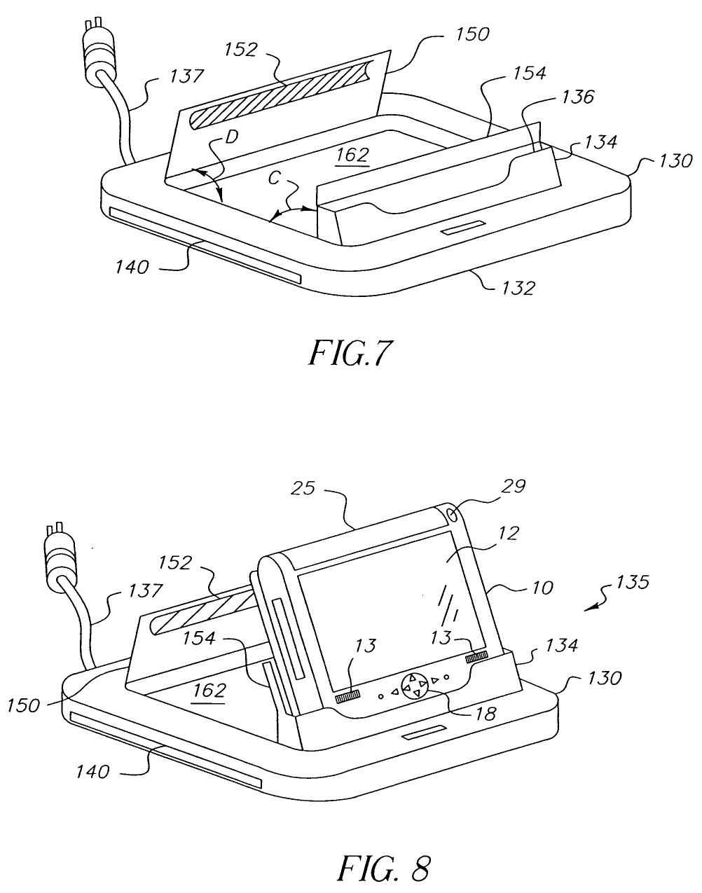

Referring now to FIG. 7, there is shown a perspective view of a scanner module 130 in accordance with the present invention. Scanner module 130 comprises a body 132 having a recessed area 162 for receiving a hardcopy print to be scanned. An aperture or slot 140 disposed in body 132 can be provided to allow a user to place/slide the hardcopy print into the recessed area 162. Scanner module 130 further comprises a support member 134 that is pivotably connected to body 132 so as to pivot in a direction as shown by arrow C in FIG. 7. Support member 134 includes a recess 136 adapted to receive and support capture device 10. Support member 134 further comprises a first illumination source 154, for example a small fluorescent lamp and reflector or the like. Scanner module 130 further comprises a second illumination source 152 disposed on a support 150, which is pivotably connected to body 132 so as to pivot in a direction as shown by arrow D in FIG. 7. Second illumination source 152 may disposed on all, or only a portion of, support 150. Scanner module 30 can further include an electrical connector 137.

Depressions or recesses can be formed in recessed area 162 to accept illumination sources 152 and 154 when not in use.

When capture device 10 is positioned in recess 136 and pivoted in a full horizontal position, capture device 10 is encased by scanner module 130 in recess area 162. When pivoting support 150 is also pivoted in a full horizontal position, it is similarly disposed within recessed area 162. As such, capture device 10 and scanner module 130 can be stored in a compact configuration.

FIG. 8 shows capture device 10 disposed within scanner module 130 to define a digital imaging system 135 in accordance with the present invention. As shown, lower edge 26 of capture device 10 is inserted into recess 136 such that the portion of capture device 10 adjacent lower edge 26 is supported within support member 134, permitting an unobstructed view of display 12 of capture device 10. That is, an image displayed in displayed 12 can be viewed while capture device 10 is docked within scanner module 130; display 12 is not obstructed from a user's view. Similarly, speakers 13 are unobstructed by support member 134 so as not to interfere with sound reproduction. Alternatively, display module 130 and support member 134 may be designed to incorporate sound directing ports and/or baffles to enhance the quality of the sound. Scanner module 130 acts as a holder or support for capture device 10. Support member 134 is pivotable to provide a proper scanning angle by a user. In a preferred embodiment, selection members 18 are accessible when capture device 10 is supported by scanner module 130 in order to initiate capture of hardcopy prints and review of the resulting digital images.

In operation, a hardcopy print is disposed within recessed area 162. To scan the hardcopy print, rotating capture assembly 25 of capture device 10 is rotated to a position that directs/aims lens 28 at the hardcopy print disposed in recessed area 162. This position of lens 28 can be set using a “detent” so that the user can easily set the proper position. Alternatively, rotating capture assembly 25 can be rotated to the proper position by a motor. For example, a user can indicate to capture device 10 by means of selection member 18 that hardcopy print capture is desired, and the motor would automatically properly position lens 28. In a preferred embodiment, lens 28 is centrally disposed on rotating capture assembly 25 so that lens 28 is generally positioned over the center of the recessed area 162 when the hardcopy print is scanned.

As indicated above, the position of lens 28 can be set using a “detent” or other registration marker/method so that the user can easily set the proper position. The positioning of lens 28 in the detent can be an indication to capture device 10 that the capture/scan of a hardcopy print is the desired activity, and capture parameters (e.g., focal length and post capture processing) can be adjusted accordingly. Similarly, if the position of support member 134 can be set using a detent, then positioning support member 134 in the detent can indicate the same condition to scanner module 130, which can communicate this condition to capture device 10. This indication may also cause the illumination sources to become active.

Once the lens is in position, activation member 29 (or other selection member 18) can be activated to initiate scanning of the hardcopy print whereby capture device 10 captures a digital still image of the hardcopy print. Upon activation, illumination sources 152, 154 can illuminate the hardcopy print for scanning. Alternatively, illumination sources 152, 154 can be activated prior to initiating scanning.

Illumination sources are preferably arranged to provide uniform illumination of the hardcopy print. As such, support 150 and support member 134 may need to be in an angled orientation (i.e., non-perpendicular to body 132). Such an orientation may depend on the intensity/amount of illumination of the illumination sources, as known to those skilled in the art. An example of a suitable angled orientation might be a 30-50 degree orientation from vertical. Illumination source 152 may be disposed at a different angled orientation than the other illumination source 154.

An optional diffusing member can be attached to support member 134. Such a diffusing member can provide for flash member 22 to be used as an illumination source. In operation, capture device 10 would be inserted in support member 134, the diffusing member would cover flash member 22 and diffuse its output. The diffusing member can be constructed such that light passing through it and onto the hardcopy print would be distributed essentially equally across the hardcopy print.

An optional focusing member can be attached to support member 134. Such a focusing member could allow capture device 10 to be used as a scanner if the optical path of the scanning operation is not within the operational ability of capture device 10. In operation, capture device 10 would be inserted in support member 134, the focusing member would be placed in front of lens 28 and the focal length would be adjusted accordingly. The focusing member could be aspheric such that the field of view of capture is closely matched to the hardcopy print. Algorithms can be applied to the captured image to remove any distortions provided by the focusing member.

The hardcopy print is preferably uniformly illuminated to provide for optimum scanning. Capture device 10 can be configured to take a “sample” illumination reading prior to scanning and compensate for any non-uniform illumination. For example, if recessed area 162 comprises a white or gray color, capture device 10 can capture an image of recessed area 162 (without the hardcopy print) to determine the illumination, and a correction for the illumination sources 152, 154 can be applied when the hardcopy print is scanned. Alternatively, if the spatial non-uniformity or color balance of the illumination is known at the time of manufacture, compensation in the form of a pre-supplied algorithm performing correction can be employed.

If the scanning of the hardcopy print is geometrically skewed, the algorithms provided can be employed to correct this condition. If lens 28 of capture device 10 is not positioned substantially above the center of the hardcopy print, a distortion known as “keystoning” might occur. This distortion can be corrected by algorithms in a manner similar to that described above.

Scanner module 130 is provided with electrical connector 137 in order to provide power to illumination sources 152, 154. Scanner module 130 can be configured as a power source for capture device 10 or as a charger for a power supply (e.g., battery) disposed within capture device 10.

Disposed within recess 136 is a communication connector (not shown) which can be matingly connected with communication port 24 of capture device 10 when capture device 10 is docked within scanner module 130. When docked, a communication network is established by connecting communication port 24 and the communication connector, thereby permitting the transfer of digital data. For example, scanner module 130 can dock to other modules to permit digital data to be printed or written to an optical disk, such as a DVD.

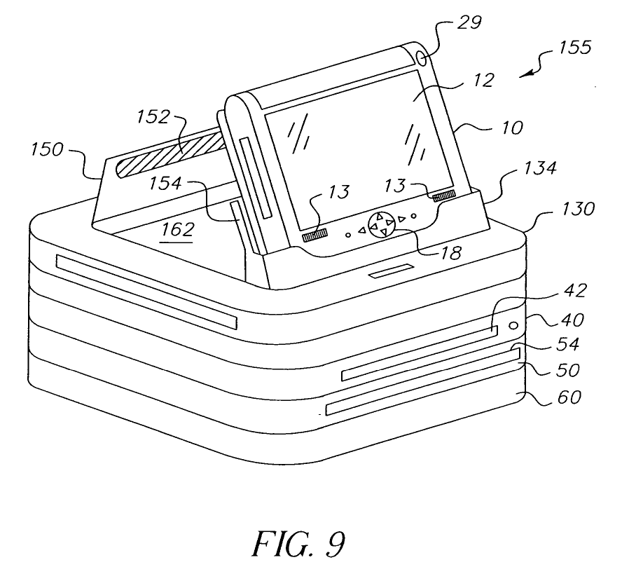

As shown in FIG. 9, scanner module 130 can be stacked/mated with the CD module 40, printer module 50, and/or another module 60. With a modular system, the order of the modules 130, 40, 50 and 60 is not relevant; any order can be employed. Access to the modules (e.g., 130, 40, 50, 60) is preferably in the same direction (i.e., on the same side) of digital imaging system 155, as shown in FIG. 9. Once docked, the electrical connection of the module is made with the other modules, particularly scanner module 130 which provides an interface to capture device 10.

In a preferred embodiment, the user interface for digital imaging system 135, 155 is not contained with module 40, 50, 60. Rather, user control would be provided by capture device 10 or scanner module 130. Accordingly, each time a module 40, 50, 60 is docked, software for the module would be uploaded or accessed by capture device 10 or scanner module 130. This software may be uploaded from firmware within the modules or via the removable digital memory device 16. As such, a cumulative user interface is provided. The user interface can be designed with a consistent look and feel for all modules added to the system.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts list

10 capture device
12 display
13 speaker
14 receiving port
16 digital storage device
17 cover member
18 selection members
20 aperture; for stylus
22 flash member/illumination device
24 communication port
25 rotating capture assembly
26 lower edge
28 lens
29 activation member
30 display module
32 body
34 support member
35 digital imaging system
36 recess
37 electrical connector
38 telephone connector/communications link
40 CD module
42 opening
50 printer module
52 hardcopy print
54 delivery aperture
55 digital imaging system
60 other module
62 display recess
130 scanner module
132 body
134 support member
135 digital imaging system
136 recess
137 electrical connector
140 slot
150 support
152 illumination source
154 illumination source
162 recessed area

1. A scanner module adapted to receive a capture device for capturing a still image, comprising:
a body having a planar support surface, a recessed area for receiving a hardcopy print to be scanned, and a support member movable relative to the planar support surface; and
the support member being adapted to receive the capture device and being positionable such that said capture device in said support member can scan said hardcopy print placed in said recess area.

2. The module according to claim 1, wherein the supporting member includes a recess for receiving and supporting the capture device.

3. The module according to claim 1, wherein the support member includes a cut-away portion whereby a display on the capture device is viewable when supported in the support member.

4. The module according to claim 1, wherein the support member further includes a first illumination source for illuminating the hardcopy print to be scanned.

5. The module according to claim 4, wherein the scanner module further includes a second illumination source for illuminating the hardcopy print to be scanned.

6. The module according to claim 1, wherein the scanner module includes an illumination source for illuminating the hardcopy print to be scanned.

7. The module according to claim 1, wherein the support member comprises a first electrical connector which mates with a connector disposed on the capture device when the capture device is received within the support member.

8. The module according to claim 7, wherein the electrical connector provides power to the capture device.

9. The module according to claim 8, wherein the power charges a battery disposed within the capture device.

10. The module according to claim 7, further comprising a second electrical connector and at least one attachment member or attachment feature for stacking the scanner module with a second module.

11. The scanner module according to claim 10, wherein the second module receives a digital image transferred from the scanner module by means of the first and second electrical connectors.

12. The module according to claim 10, wherein the second module provides a DVD writing function.

13. The module according to claim 10, wherein the second module provides a printing function.

14. The module according to claim 1, wherein the capture device received within the support member includes an illumination device for illuminating the hardcopy print, and the scanner module further includes a diffusing member adapted to diffuse the light of the illumination device.

15. A scanner module adapted to receive a capture device for capturing a still image, comprising:
a body having a planar support surface, a recessed area for receiving a hardcopy print to be scanned, and a movable support member pivotable relative to the planar support surface; and
the movable support member being adapted to receive the capture device, the support member being movable between a first and a second position, the first position provides a scanning position and the second position provides a storage position wherein the capture device is substantially disposed within the recessed area.

16. The module according to claim 15, wherein the support member further includes a first illumination source for illuminating the hardcopy print to be scanned.

17. The module according to claim 16, wherein the scanner module further includes a second illumination source for illuminating the hardcopy print to be scanned.

18. The module according to claim 15, wherein the scanner module includes an illumination source for illuminating the hardcopy print to be scanned.

19. A scanner module, comprising:
a body defining a recessed area for receiving a hardcopy print to be scanned;
a support member adapted to accept a capture device, the support member being pivotably connected to the body about an axis between a first position and a second position wherein the support member is disposed substantially within the recessed area, said capture device is capable of scanning said hardcopy print in said recessed area when said support member is in the first position; and
power means adapted to provide power to the capture module.

20. The module according to claim 19, wherein the first position defines an upright position for the capture device and the second position defines a horizontal position for the capture device.

21. The module according to claim 19, wherein the support member further includes an illumination source for illuminating the hardcopy print to be scanned.

22. The module according to claim 19, wherein the recessed area is of a size adapted to support the capture device within the recessed area when the capture device is accepted by the support member and the support member is in the second position.

23. A system for scanning a hardcopy print, comprising:
a still image capture device including a capture assembly having a lens and a display for displaying captured images, the capture assembly pivoting relative to the display; and
a scanner module including a body having a planar support surface including an area for receiving the hardcopy print to be scanned, and a support member angled relative to the planar support surface, the support member being adapted to receive the still image capture device and being positioned such that said still image capture device in said support member can scan said hardcopy print placed on said planar support surface.

24. The module according to claim 23, wherein the scanner module further includes an illumination source for illuminating the hardcopy print to be scanned.

25. The module according to claim 24, wherein the illumination source is provided on the support member.

26. The module according to claim 24, wherein the scanner module further includes a second illumination source for illuminating the hardcopy print to be scanned.

27. The system according to claim 23, wherein a first position of the lens defines a capture mode wherein the system is configured to scan the hardcopy print.

28. The system according to claim 23, wherein a first position of the support member defines a capture mode wherein the system is configured to scan the hardcopy print.

29. The system according to claim 23, wherein the capture device includes algorithms which can be applied to correct distortions of the system.
